(19) United States
(12) Patent Application Publication
(10) Pub. No.: US 2026/0084231 A1
(43) Pub. Date: Mar. 26, 2026

(54) Orbital Welding Device with Electrode Ring Segment

(71) Applicant: Viega Technology GmbH & Co. KG, Attendorn (DE)

(72) Inventors: Daniel Knupfer, Zizers (CH); Thomas Knupfer, Scharans (CH); Patric Cathomas, Laax (CH)

(21) Appl. No.: 19/250,735

(22) Filed: Jun. 26, 2025

(30) Foreign Application Priority Data
Jun. 28, 2024 (DE) 10 2024 118 370.5

(51) Int. Cl. B23K 11/093; B23K 11/28; B23K 11/30

(52) U.S. Cl. CPC B23K 11/0935; B23K 11/28; B23K 11/30

(57) ABSTRACT

The invention relates to an orbital welding device with a welding head that has a receptacle for positioning a joining area of two joining partners, in particular a fitting and a pipe end which joining partners are tubular at least in the joining area, wherein The welding head has an electrode ring segment which is arranged in the circumferential direction around the receptacle and is mounted in such a way that the electrode ring segment can be rotated about an imaginary longitudinal axis of the receptacle. The electrode ring segment has an electrode holder for a welding electrode and/or a welding electrode. The welding head has drive means, in particular one or more driven drive wheels, for driving the electrode ring segment about the imaginary longitudinal axis. The invention further relates to a system, with such an orbital welding device and an orbital welding method.

### CROSS-REFERENCE TO RELATED APPLICATION

This application claims priority to German Patent Application No. 10 2024 118 370.5 filed Jun. 28, 2024, the disclosure of which is hereby incorporated by reference in its entirety.

### BACKGROUND OF THE INVENTION

### Field of the Invention

The present invention relates to an orbital welding device with a welding head that has a receptacle for positioning a joining area of two joining partners, in particular a fitting and a pipe end, which joining partners are tubular at least in the joining area. The present invention further relates to a system with such an orbital welding device and an orbital welding method.

### Description of Related Art

In the prior art, arc-based orbital welding methods, in particular tungsten inert gas welding methods (TIG welding methods), are used, for example, for the material-locking connection of pipes. In this process, the pipe ends to be joined are arranged next to each other, typically in a butt joint, and welded together by moving the welding tool in the circumferential direction of the pipes (orbitally) around the joint. The welding torch can be guided manually or automatically.

On the outside of the pipes, tarnishing can be largely suppressed by the shielding gas used in TIG welding, although oxidation may still occur after the welding process due to residual heat in the workpiece. Additional measures are required to protect the inner surface of the pipes from oxidation, such as flushing the pipes with forming gas.

Orbital welding of copper pipes has proven to be particularly difficult in this respect. Due to the good thermal conductivity of copper, the heat introduced into the material from the outside during the welding process is quickly dissipated, requiring higher amounts of energy to reach the necessary temperatures at the weld site. This is accompanied by higher energy requirements, which makes the use of battery-powered welding equipment difficult. In addition, the high thermal conductivity of copper causes the inner surface of the pipe to heat up significantly, making it particularly susceptible to tarnishing and oxidation on the inside of the pipe.

It has been found that the orbital welding process can be optimized in such a way that, even when welding copper, there is less heating of the inner surface of the pipe and thus less susceptibility to tarnishing and oxidation on the inside of the pipe. It has been found that, for such process optimization, it is particularly advantageous to align the electrode and the joining partners as precisely as possible and to guide the electrode as precisely as possible during the welding process. However, the known orbital welding devices are in need of improvement in terms of precision and/or are quite large or complex, so that they are not particularly suitable for orbital welding devices designed as hand-held devices.

Against this background, the present invention has the object of providing an orbital welding device, a system with such an orbital welding device, and an orbital welding method with which at least some of the aforementioned problems can be reduced or avoided.

### SUMMARY OF THE INVENTION

The aforementioned object is solved according to the invention by an orbital welding device with a welding head that has a receptacle for positioning a joining area of two joining partners, in particular a fitting and a pipe end, which joining partners are tubular at least in the joining area, wherein the welding head has an electrode ring segment which is arranged in the circumferential direction around the receptacle and is mounted in such a way that the electrode ring segment can be rotated about an imaginary longitudinal axis of the receptacle, wherein the electrode ring segment has an electrode holder for a welding electrode and/or a welding electrode, and wherein the welding head has drive means, in particular one or more driven drive wheels, for driving the electrode ring segment about the imaginary longitudinal axis.

Preferably, the welding head has a plurality of driven drive wheels which are arranged in such a way that, in each rotational position of the electrode ring segment about the imaginary longitudinal axis, at least one of the plurality of drive wheels is coupled to the electrode ring segment.

It has been found that in this way a welding electrode can be moved precisely in the circumferential direction around the joining area of tubular joining partners. In particular, the described mechanism enables such precise electrode guidance that the welding process can be carried out with very small and precisely maintained distances between the welding electrode tip and one or both of the joining partners, which enables better optimization of the welding process in order to reduce the energy requirement and the heating of the inner surface of a pipe end to be joined and thus the susceptibility to tarnishing and oxidation on the inner side of the pipe.

The receptacle of the welding head of the orbital welding device is for positioning a joining area of two joining partners that are tubular at least in the joining area. Both joining partners each have a joining area in which the joining partners are to be welded together. In the case of a push-on fitting, the joining area of the fitting may, for example, comprise an area at the fitting opening, and the joining area of a pipe end to be welded thereto may comprise the area of the pipe end which is located at the fitting opening when the fitting is pushed on. In the case of an insertion fitting, the joining area of the fitting may, for example, comprise an area at a stop edge for a pipe end, and the joining area of a pipe end to be welded to it may comprise the area of the pipe opening which abuts against the stop edge when the fitting is inserted. The joining area of the fitting and the joining area of the pipe end, or more generally the respective joining areas of the two joining partners, together form the joining area of the two joining partners.

In addition to the two joining partners, further joining partners may also be provided.

The receptacle has a longitudinal extension, wherein the receptacle is designed to accommodate a joining area of two tubular joining partners with their longitudinal extension in the longitudinal extension of the receptacle.

The welding head has an electrode ring segment which is arranged in the circumferential direction around the receptacle and is mounted in such a way that the electrode ring segment can be rotated about an imaginary longitudinal axis of the receptacle. For this purpose, the welding head preferably has a circumferential guide, for example a guide groove, for mounting the electrode ring segment. In particular, the electrode ring segment has a ring segment opening in the circumferential direction by which the electrode ring segment is interrupted in the circumferential direction.

The electrode ring segment has an electrode holder for a welding electrode and/or a welding electrode. The provision of an electrode holder allows the welding electrode to be easily replaced. The electrode holder may, for example, have a receptacle and fastening means, such as a grub screw, for fixing a welding electrode in the electrode holder. The electrode holder may also have a thread, in particular an internal thread, as a fastening means. In this way, a welding electrode provided with a corresponding thread, in particular an external thread, can be screwed into the holder and thus fixed in the electrode holder. The electrode holder is preferably designed for a pin-shaped welding electrode.

The welding head has drive means for driving the electrode ring segment about the imaginary longitudinal axis. In this way, the electrode ring segment can be moved in the circumferential direction around the receptacle or the joining area of two joining partners arranged therein in order to carry out the orbital welding process. One or more driven drive wheels may constitute the drive means. Accordingly, the welding head preferably has one or more driven drive wheels for driving the electrode ring segment about the imaginary longitudinal axis. In this way, the electrode ring segment can be moved in the circumferential direction around the joining area of tubular joining partners.

The welding head preferably has a plurality of driven drive wheels which are arranged in such a way that, in each rotational position of the electrode ring segment about the imaginary longitudinal axis, at least one of the plurality of drive wheels is coupled to the electrode ring segment. This ensures reliable guidance of the electrode ring segment. Preferably, the electrode ring segment can be rotated through an angle of at least 340°, in particular at least 360°, and more preferably more than 360°, in particular arbitrarily. In particular, the electrode ring segment can preferably assume any rotational position between 0° and 360°.

The drive wheels are preferably arranged on one side of the electrode ring segment. This facilitates electrically contacting the electrode ring segment from the other side.

The aforementioned object is further solved according to the invention by means of a system with the orbital welding device described above or an embodiment thereof and with a fitting. The fitting is in particular designed to be used together with the orbital welding device to produce a material-locking connection between the fitting and a joining partner, in particular a pipe end, by means of orbital welding. For this purpose, the fitting is preferably adapted to the geometry of the orbital welding device. In particular, the fitting and the welding head of the orbital welding device may have corresponding contours, such as an outer contour of the fitting and a corresponding fitting fixing contour of the welding head, in order to position the fitting in a predetermined fitting position in the welding head. The fitting position is preferably such that the joining area of the fitting, for example an edge of the fitting at which the fitting is to be welded to the pipe end, is located in the area of the electrode ring segment or in the area of the welding electrode, in particular at a predetermined distance, of for example less than 1.5 mm, in particular less than 1.2 mm, between the tip of the welding electrode and the edge of the fitting. In particular, the predetermined distance may be a maximum of 1.2 mm, preferably a maximum of 1.1 mm. In particular, the specified distance may be in the range of 0.15-1.2 mm, preferably 0.25-1.1 mm, more preferably 0.35-1.0 mm.

In one embodiment, in particular if the fitting is a push-on fitting, the specified fitting position is such that the tip of the welding electrode has a radial distance from the outer surface of the pipe end in the range of 0.3-1.5 mm, preferably 0.4-1.4 mm, more preferably 0.5-1.3 mm, in particular 0.60-0.80 mm, and/or an axial distance from the weld edge or stop edge in the range of 0.15-1.2 mm, preferably 0.25-1.1 mm, more preferably 0.35-1.0 mm, in particular 0.40-0.70 mm. In this embodiment, the welding electrode is preferably aligned obliquely inwardly with respect to the longitudinal direction for reception.

In one embodiment, in particular when the fitting is an insertion fitting, the specified fitting position is such that the tip of the welding electrode has a radial distance from the outer surface of the pipe end and/or from the outer surface of the fitting in the range of 0.3-1.5 mm, preferably 0.4-1.4 mm, in particular 0.40-0.80 mm. In this embodiment, the welding electrode is preferably aligned radially inward toward the receiving end with respect to the longitudinal direction.

In addition or alternatively, the welding head and the fitting may be designed to hold the fitting in the specified fitting position by means of a force-fit. For this purpose, a fixing element made of an elastomer may be arranged in the welding head, for example, which fixing element forms a fixing surface against which the fitting is pressed in the closed position of the welding head.

The fitting may in particular comprise a fitting body made of metal, for example copper or a copper alloy. In particular, the fitting body may form the outer contour of the fitting.

The aforementioned object is further solved according to the invention by an orbital welding method carried out with an orbital welding device, in particular with the orbital welding device described above or an embodiment thereof, in which two joining partners, which are tubular at least in a joining area, are arranged relative to each other, in particular in a lapped joint, in which a chain of joining spots (welding spots) extending in the circumferential direction of the joining partners is produced in the joining area, which chain connects the joining partners in a material-locking manner.

In the orbital welding process, in particular, the electrode ring segment for producing the chain of joining spots is moved in the circumferential direction, preferably over an angle of at least 340°, in particular at least 360°. In this way, a chain of joining spots can be produced, which chain is preferably closed in the circumferential direction, without having to realign the orbital welding device and joining partners in the meantime. The moving of the electrode ring segment can be carried out continuously or stepwise, in particular between the creation of two joining spots in each case. The joining spots are preferably placed next to each other in an overlapping manner.

Various embodiments of the orbital welding device, the system, and the orbital welding method are described below, whereby the individual embodiments apply independently of each other to the orbital welding device, the system, and the orbital welding method. In addition, the individual embodiments can be combined with each other as desired.

In one embodiment, the electrode ring segment is designed as a bevel gear wheel segment and the one or more drive wheels are designed as drive bevel gear wheels. This enables compact mechanical coupling of the drive wheels with the electrode ring segment.

Preferably, the electrode ring segment is designed as a bevel gear wheel segment and the one or more drive wheels as drive bevel gear wheels, whereby preferably in each rotational position of the electrode ring segment around the imaginary longitudinal axis, at least one of the drive gear wheels meshes with the bevel gear wheel segment. In this way, precise motion transmission from the drive wheels to the electrode ring segment and thus precise motion of the electrode ring segment is achieved.

In one embodiment, the plurality of drive wheels are arranged in the circumferential direction around the receptacle. In this way, if one drive wheel loses contact with the electrode ring segment at the ring segment opening, an adjacent drive wheel can take over the drive of the electrode ring segment.

In one embodiment, in particular of the orbital welding device, the axes of rotation of the drive wheels lie in a plane perpendicular to the imaginary longitudinal axis of the receptacle. In this way, uniform drive of the electrode ring segment is possible without the electrode ring segment and drive wheels becoming misaligned.

In one embodiment, at least two of the plurality of drive wheels are rotationally coupled to one another, preferably by coupling wheels, preferably coupling bevel wheels, in particular coupling bevel gear wheels, provided between the drive wheels. Preferably, at least three of the plurality of drive wheels or all of the plurality of drive wheels can be rotationally coupled to each other, in particular by coupling wheels provided between the drive wheels. In this way, the synchronous drive of the electrode ring segment by the plurality of drive wheels can be mechanically ensured. In addition, the number of required electrode drives, in particular motors, can be reduced in this way, in particular to one. The provision of coupling wheels, in particular coupling bevel wheels, enables space-saving and cost-effective coupling of the drive wheels.

It is also conceivable to provide several electrode drives, in particular several motors, for example stepper motors, each of which drives one or a group of drive wheels.

In one embodiment, the orbital welding device has an electrode drive, in particular a motor, which is rotationally coupled to at least one of the drive wheels for driving it. If the orbital welding device comprises a hand-held device or if the orbital welding device is designed entirely as a hand-held device, the electrode drive, in particular the motor, may be accommodated, for example, in the shaft or handle part of the hand-held device. The motor may be, for example, a stepper motor.

In one embodiment, contacting means are provided for electrically contacting the electrode ring segment or a welding electrode on the electrode ring segment and are preferably designed for contacting in every rotational position of the electrode ring segment. The contacting means are designed in particular for electrically connecting the electrode ring segment or a welding electrode on the electrode ring segment to a welding current source or to a connection for a welding current source.

The contacting means preferably comprise one or more contacting elements fixed relative to the welding head, which contacting elements are arranged in the region of the rotationally mounted electrode ring segment, preferably in the axial direction adjacent to the electrode ring segment. Furthermore, the contacting means preferably comprise one or more conductors which electrically connect the contacting elements to the welding current source or to a connection for a welding current source.

The contacting means preferably have conductor cross-sections that are continuously designed for at least 200 A, in particular at least 300 A. In this way, the welding current can be transmitted safely and with as little loss as possible from the welding current source to the welding electrode during operation.

In one embodiment, a contact ring segment is arranged next to the electrode ring segment, which contact ring segment is electrically conductively connected to a welding current source or to a connection for a welding current source. The electrode ring segment is preferably electrically conductive on the side facing the contact ring segment. In this way, large-area electrical contact between the contact ring segment and the electrode ring segment can be achieved, in particular even at different angles of rotation, so that the welding current can be transmitted as safely, reliably, and with as little loss as possible during operation. The contact ring segment and the electrode ring segment are preferably both C-shaped with a respective ring segment opening in the circumferential direction.

Preferably, the contact ring segment extends in the circumferential direction around a substantially equal angular range as the electrode ring segment, i.e., the respective ring segment opening of the contact ring segment and of the electrode ring segment is preferably substantially equal in size in the circumferential direction. The contact ring segment forms in particular a contact element of the contact means.

In one embodiment, the electrode ring segment is designed in multiple parts with a drive ring segment for coupling with the drive wheels and with a conductor ring segment for contacting the electrode ring segment. The drive ring segment is preferably electrically insulating. In this way, the drive mechanism of the electrode ring segment can be separated from the strong welding current, thereby improving the reliability and safety of the orbital welding device. The conductor ring segment is preferably electrically conductive at least in sections, and particularly preferably over its entire surface. In this way, electrical contact between the conductor ring segment and the contacting means can be established over as large an area as possible in order to transfer the welding current to the electrode ring segment. Preferably, the electrode holder or a contacting element for contacting a welding electrode held by the electrode holder is electrically conductively connected to the conductor ring segment or is preferably formed by the conductor ring segment.

Preferably, the drive wheels are arranged on one side of the electrode ring segment, wherein preferably the drive ring segment forms the side of the electrode ring segment facing the drive wheels and the conductor ring segment forms the side of the electrode ring segment facing away from the drive wheels and, in particular, facing the contact means.

The drive ring segment is preferably bevel-wheel-shaped, in particular bevel-gear-wheel-shaped.

The electrode ring segment is preferably divided with respect to a plane transverse to the imaginary longitudinal axis, the drive element lying essentially on one side and the conductor ring segment lying essentially on the other side of the plane.

In one embodiment, pressing means are provided which are designed to press the electrode ring segment and one or more contacting elements of the contacting means against each other. The one or more contacting elements may in particular comprise the contacting ring segment according to one of the embodiments described above.

In a multiple-parts electrode ring segment with a conductor ring segment, the pressing means are designed in particular to press the conductor ring segment and a contacting element against each other. In this way, continuous, vibration-proof, flat electrical contact between the electrode ring segment and the contacting element can be ensured so that the welding current can be conducted to the welding electrode without interruption.

The pressing means are preferably designed to press the electrode ring segment against the one or more contacting elements. In this way, the play in the bearing of the electrode ring segment during the rotational movement of the electrode ring segment is reduced by the pressing force exerted by the pressing means.

Alternatively or additionally, it is conceivable that the pressing means are designed to press the one or more contacting elements against the electrode ring segment.

The pressing means preferably comprise one or more pressing elements, in particular spring-loaded pressing elements, which preferably exert a force in the axial direction on the electrode ring segment and/or the one or more contacting elements.

In one embodiment, the pressing means comprises a plurality of pressing elements, in particular spring-loaded pressing elements, which are distributed in the circumferential direction. By providing a plurality of pressing elements distributed in the circumferential direction, it can be achieved that the electrode ring segment and the one or more contacting means are preferably pressed against each other by at least one pressing element at each rotary position of the electrode ring segment. Preferably, two, more preferably at least three pressing elements distributed in the circumferential direction are provided.

In one embodiment, the orbital welding device comprises a welding current source which is electrically connected to the electrode ring segment, the welding electrode and/or the electrode holder therefor, in particular via the contacting means. Furthermore, the welding current source is preferably connected to one or more contacting elements for contacting a joining partner arranged in the receptacle. In this way, a voltage can be applied between the welding electrode and the joining partner during operation using the welding current source. The welding current source is preferably configured to provide an ignition voltage for contactless ignition of an arc between the welding electrode and the joining partner. Furthermore, the welding current source is preferably configured to provide a welding current for the orbital welding process, in particular to control the welding current according to a predetermined or predeterminable welding current characteristic curve.

In one embodiment, the welding head has a first opening and a second opening opposite the first opening, between which the receptacle extends in the longitudinal direction. In this way, two joining partners to be arranged with the joining area in the receptacle, in particular a fitting and a pipe end, can extend out of the first and second openings.

The welding head surrounds the receptacle, in particular at least in sections in an azimuth direction.

The first and second openings may be connected to each other. In particular, the welding head may be adjustable between an open position and a closed position, wherein the welding head, in the open position, has an insertion opening connecting the first and second opening for inserting a joining area of two joining partners, which are tubular at least in the joining area, into the receptacle, and wherein the insertion opening is at least partially closed in the closed position. The insertion opening forms, in particular, an azimuthal insertion region. In this way, in the open position, the two joining partners can be inserted into the receptacle with the joining region through the insertion opening, i.e., the welding head may in particular be placed on the joining partners, in particular a pipe end and a fitting, from the side, in particular if these are already arranged relative to one another, for example, are inserted into one another. In the closed position, the two joining partners can be fixed with the joining area in the receptacle. Preferably, the insertion opening is completely closed in the closed position. This provides better protection for the user against UV radiation and welding fumes. Furthermore, the escape of protective gas can be largely prevented.

In one embodiment, the orbital welding device comprises an adjustment mechanism and a closure actuator for actuating the adjustment mechanism, wherein the adjustment mechanism is designed to adjust the welding head between the open position and the closed position. The closure actuator is preferably mechanically operable. The adjustment mechanism may in particular comprise one or more closure ring segments, preferably driven in opposite directions.

In one embodiment, the electrode ring segment has, in particular, a ring segment opening in the circumferential direction, which preferably forms part of the insertion opening when the welding head is in the open position. In this way, the electrode ring segment clears the insertion opening when the welding head is in the open position. For this purpose, a control device of the orbital welding device may be designed, for example, to rotate the electrode ring segment after completion of a welding process such that the ring segment opening forms part of the insertion opening.

In one embodiment, the orbital welding device comprises a hand-held device which comprises the welding head and preferably a handle connected to the welding head. Preferably, the welding current source and the control device may also be accommodated in the hand-held device. In addition, the hand-held device may have a battery or a rechargeable battery, a receptacle or a connection therefor, in particular for an exchangeable rechargeable battery. For example, a connection for plugging in an exchangeable rechargeable battery may be provided. In this way, flexible and simple operation of the orbital welding device is also possible under cramped working conditions.

Preferably, the orbital welding device is designed entirely as a hand-held device, in particular with an integrated or pluggable rechargeable battery, in particular a exchangeable rechargeable battery. This allows particularly flexible and easy use of the orbital welding device.

It is also conceivable that the orbital welding device comprises, in addition to the hand-held device, at least one case or backpack connected to the hand-held device, for example by means of a hose package, in which case or backpack components of the orbital welding device, such as the welding current source and/or a battery or rechargeable battery or a receptacle therefor, are arranged. In this way, the hand-held device can be made more compact and lighter, which makes it easier to operate. At the same time, the orbital welding device remains mobile.

In one embodiment, in particular of the orbital welding device, a control unit is provided which is configured to control the orbital welding device in such a way that, by means of the welding electrode, a weld seam consisting of a circumferential chain of joining spots is produced on two joining partners arranged in the receptacle. For this purpose, the control unit preferably comprises at least one processor and at least one memory with commands whose execution on the at least one processor causes corresponding control of the orbital welding device. The memory may be, for example, a ROM memory or a RAM memory. In particular, the control device of the orbital welding device may control the welding current source and/or the electrode drive.

### BRIEF DESCRIPTION OF THE DRAWINGS

Further features and advantages of the orbital welding device, the system, and the orbital welding method emerge from the following description of embodiments, with reference being made to the accompanying drawing.

In the Drawings

FIG. 1 shows a first exemplary embodiment of the orbital welding device,

FIGS. 2a-d show the welding head of the orbital welding device from FIG. 1,

FIG. 3 shows a schematic block diagram of the functional components of the orbital welding device from FIG. 1,

FIG. 4 shows a schematic block diagram of the welding current source of the orbital welding device from FIG. 1,

FIGS. 5a-b show a schematic representation of the creation of a joining spot in the orbital welding process,

FIGS. 6a-c show an exemplary embodiment of the orbital welding method on a fitting and a pipe end, FIG. 7 shows another exemplary embodiment of the orbital welding device, and

FIGS. 8a-i show detailed views of the welding head of the orbital welding device from FIGS. 1 or 7.

### DESCRIPTION OF THE INVENTION

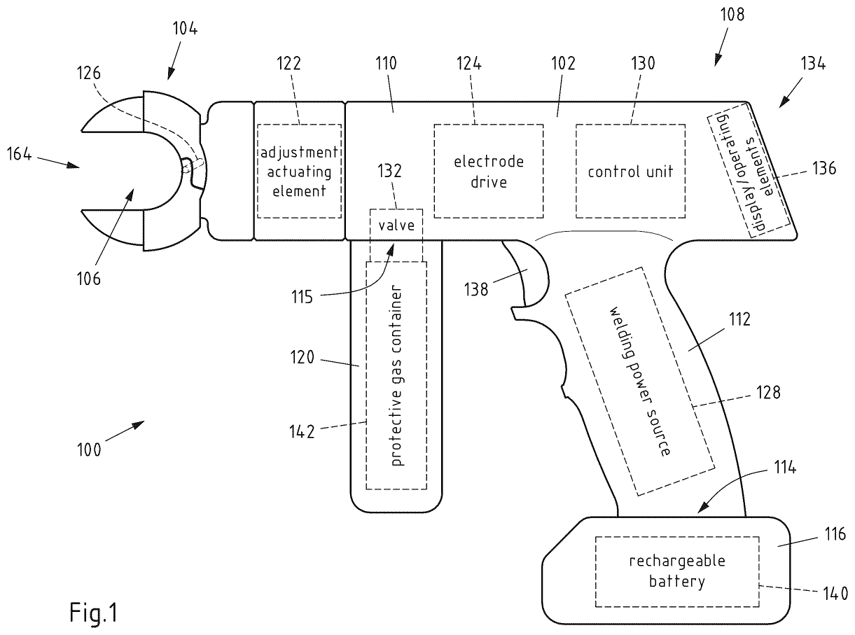

FIG. 1 shows an exemplary embodiment of the orbital welding device in schematic representation.

The orbital welding device 100 is designed as a mobile welding device in the form of a hand-held device 102. In the present exemplary embodiment, the hand-held device 102 comprises all components of the orbital welding device 100, so that the orbital welding device 100 can be handled very flexibly, even in difficult installation situations.

First, the hand-held device 102 comprises a welding head 104, which has a receptacle 106 in which a joining area of two joining partners, for example a pipe end and a fitting, can be arranged.

The hand-held device 102 further comprises a handle part 108 with a shaft 110 on which the welding head 104 is arranged, and with a handle 112 for holding and operating the hand-held device 102. The handle 112 has a connection 114 for an exchangeable rechargeable battery unit 116 at its end opposite the shaft 110. The shaft 110 further has a connection 115 for an exchangeable protective gas magazine 120.

The handle part 108 houses various components for operating the orbital welding device 100, namely in particular an adjustment actuating element 122 for adjusting the welding head 104 between an open and a closed position, an electrode drive 124 for driving a welding electrode 126 in the welding head 104, a welding current source 128 for supplying the ignition voltage and the welding current for the orbital welding process, a control unit 130 for controlling the orbital welding device 100, a valve 132 for controlling the protective gas supply, and a user interface 134 comprising display and operating elements 136 for configuring the orbital welding device 100 and a trigger 138 for starting an orbital welding process. Furthermore, the rechargeable battery unit 116 comprises a rechargeable battery 140, for example a lithium-ion rechargeable battery, and the protective gas magazine 120 comprises a protective gas container 142.

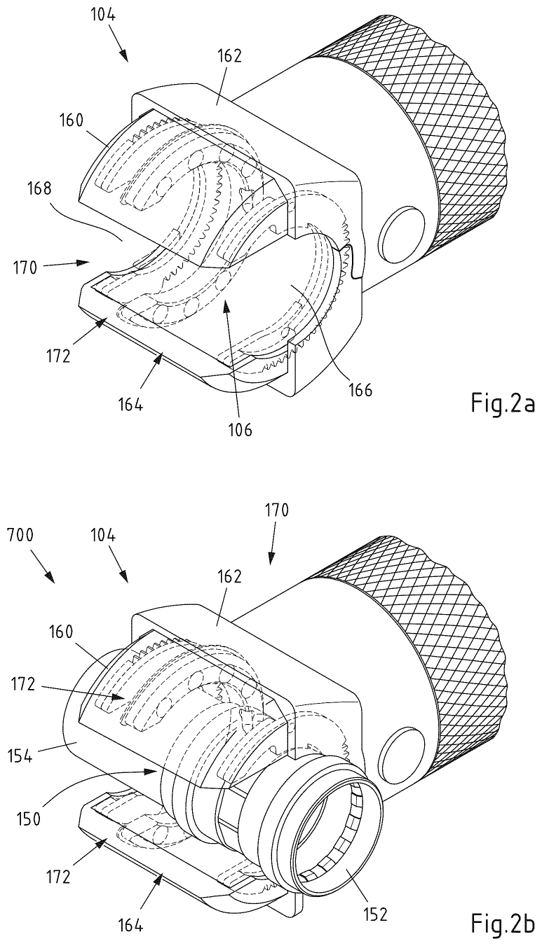

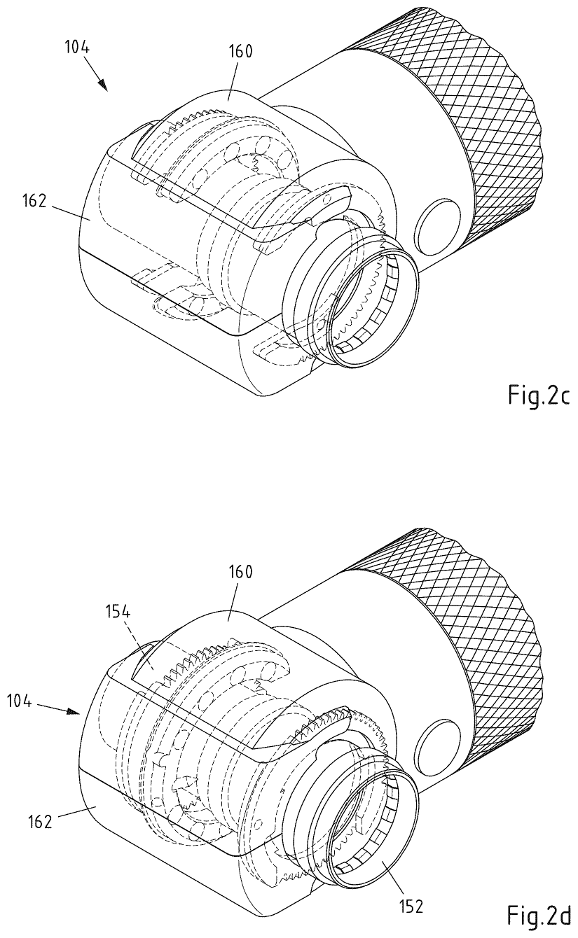

FIGS. 2a-d show the welding head 104 of the orbital welding device 100 in a schematic, perspective view, namely in the open position (FIG. 2a), in the open position after a joining area 150 of two joining partners, namely a fitting 152 and a pipe end 154, has been arranged in the receptacle 106 (FIG. 2b), and in the closed position before (FIG. 2c) and during the execution of an orbital welding process (FIG. 2d).

The welding head 104 has a fixed part 160, which surrounds the receptacle 106 in sections in the circumferential direction, and a movable part 162. In the open position, the movable part 162 is at least partially retracted into the fixed part 160 and exposes an insertion opening 164 in the circumferential direction. In the closed position, the movable part 162 closes the insertion opening 164 so that the receptacle 106 is essentially completely closed in the circumferential direction. In axial direction (longitudinal direction), the receptacle 106 extends between a first opening 166 and a second opening 168.

An adjustment mechanism 170 is provided on the welding head 104 for adjusting the welding head 104 between the open and closed positions. Furthermore, an electrode circulation mechanism 172 is provided on the welding head 104, with which, in the closed position of the welding head 104, the welding electrode 126 can be moved in the circumferential direction around the receptacle 106 for carrying out an orbital welding process.

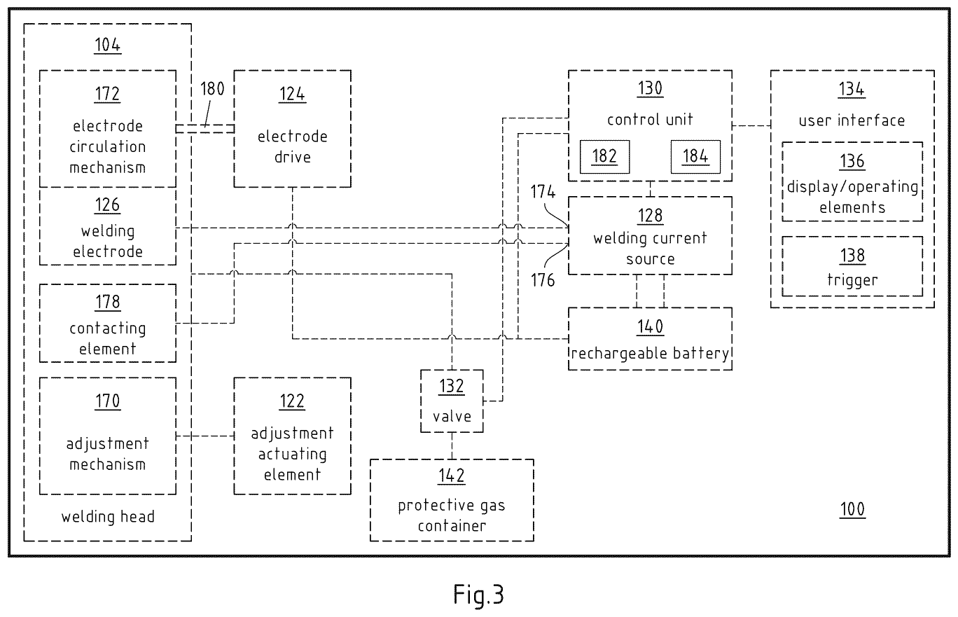

FIG. 3 shows a schematic block diagram of the functional components of the orbital welding device 100 from FIG. 1. The rechargeable battery 140 supplies all electrical components of the orbital welding device 100 with electrical energy. In particular, the rechargeable battery 140 supplies the welding current source 128, the control unit 130, and the electrode drive 124.

The welding current source 128 provides the ignition voltage for arc ignition and the welding current for the orbital welding process. For this purpose, the welding current source 128 has two outputs 174, 176, one of which, during an orbital welding process, is electrically conductively connected to the welding electrode 126 and the other of which is electrically conductively connected to one or more contacting elements 178 for contacting a joining partner arranged in the receptacle 106.

The electrode drive 124 preferably comprises an electric motor and is connected, for example via an axle 180, to the electrode circulation mechanism 172 in order to transmit the movement, for example rotary motion, from the electric motor to the electrode circulation mechanism 172 so that the electrode circulation mechanism 172 moves the welding electrode around the receptacle 106.

The control unit 130 is configured to control the orbital welding device 100 and, for this purpose, may in particular comprise at least one microprocessor 182 and a memory 184 with commands whose execution on the at least one microprocessor 182 causes controlling of the orbital welding device 100.

Furthermore, the control unit 130 is connected to the user interface 134 in order to output user outputs, for example via a screen comprised by the display and operating elements 136, and to receive user inputs, for example via buttons or a touchscreen comprised by the display and operating elements 136 or from the trigger 138.

The control unit 130 is in particular configured for controlling an orbital welding process. For this purpose, the control unit 130 is connected in particular to the electrode drive 124, to the valve 132 for controlling the protective gas flow to the welding head 104, and to the welding current source 128 for controlling them.

In the present exemplary embodiment, the adjustment actuating element 122 is designed in a mechanical manner so that a user can drive the adjustment mechanism 170 by manually actuating the adjustment actuating element 122 in order to adjust the welding head 104 between the closed and open position. However, it is also conceivable that the adjustment actuating element 122 is motorized, for example, has an electric motor that can be controlled via the control unit 130, so that the welding head 104 can be automatically adjusted between the closed and open position.

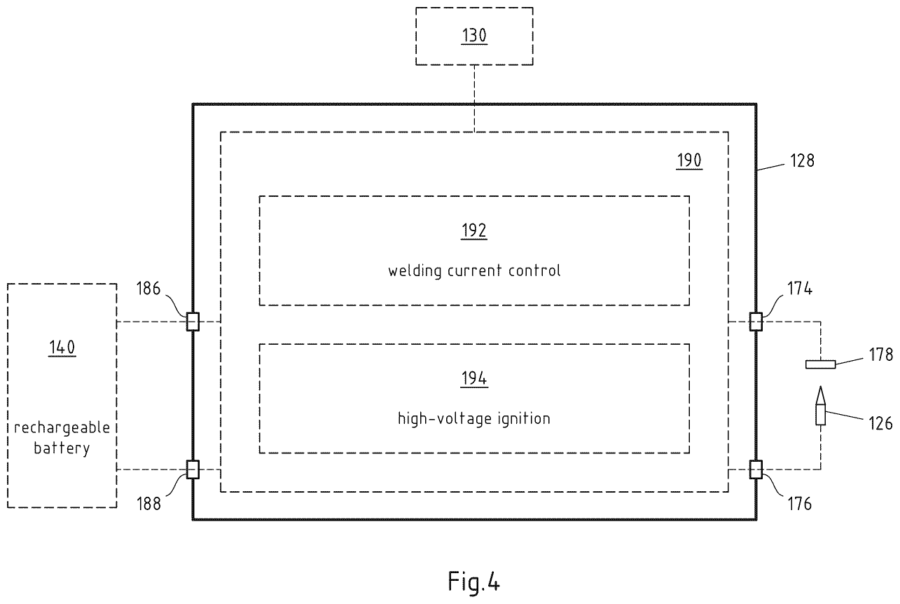

The protective gas container 142, which contains a protective gas, in particular an inert gas, and is preferably exchangeable, is connected to the welding head 104 via the valve 132, wherein the welding head 104 preferably has a protective gas duct for bringing the protective gas for the orbital welding process into the region of the welding electrode 126. FIG. 4 shows a schematic block diagram of the functional components and connections of the welding current source 128. The welding current source 128 has two inputs 186, 188 for connecting the two poles of the rechargeable battery 140 and the two outputs 174, 176 for supplying the ignition voltage and the welding current and for electrically conductive connection to the contacting element 178 and the welding electrode 126.

The welding current source 128 has an electronic circuit 190 which is supplied by the voltage, in particular direct voltage, applied to the inputs 186, 188 and can supply an ignition voltage for igniting an arc and a welding current for feeding an arc welding process via the outputs 174, 176. The electronic circuit 190 may, for example, comprise one or more electronic switches, in particular a half-bridge circuit, and preferably at least one coil. The electronic circuit 190 may further comprise its own control unit, for example a microprocessor, which controls the operation of the welding current source 128, in particular by controlling one or more switches of the electronic circuit 190.

The electronic circuit 190 is functionally configured to provide a high-voltage pulse at the outputs 174, 176 for igniting the welding arc. This is illustrated in FIG. 4 by the functional module HV ignition 194. Furthermore, the electronic circuit 190 is configured to effect a welding current control with which the amperage of a welding current flowing via the outputs 174, 176, i.e. the welding current amperage, can be controlled, in particular in accordance with a predetermined current characteristic curve. This is illustrated in FIG. 4 by the functional module welding current control 192.

Accordingly, the control unit of the welding current source 128 may in particular be configured to cause generation of a high-voltage pulse for igniting a welding arc and then supply of a welding current for an orbital welding process, in particular to cause a welding current control. The control unit of the welding current source 128 is preferably configured to control the welding current according to a predetermined or predeterminable welding current characteristic curve when the arc is burning.

The welding current source 128 is connectable to or connected to the control unit 130 and can thus be controlled by the control unit 130. In particular, the control unit 130 may control the control unit of the welding current source 128 in order to initiate and/or configure the control of the operation of the welding current source 128 by the control unit of the welding current source 128.

Instead of two separate control units, it is also conceivable that the control unit 130 and the control unit of the welding current source 128 are designed as a common control unit, for example as one microprocessor.

In the following, the execution of an orbital welding process with the orbital welding device 100 is described, namely the execution of an orbital welding process on a pipe end 154 and a fitting 152.

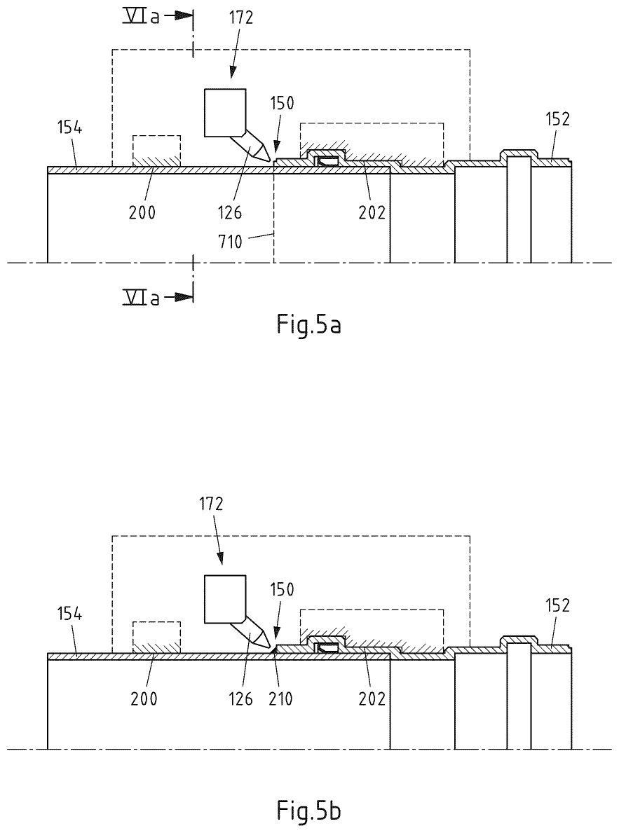

FIGS. 5a-b each show a schematic cross-sectional view of the joining area 150 of fitting 152 and pipe end 154 arranged in the welding head 104, wherein the figures show only an upper half. The shown components of the welding head 104 are partially shown in dashed lines.

The fitting 152 is pushed onto the pipe end 154, as shown in FIG. 5a. For this purpose, the inner cross-section of the fitting 152 is preferably adapted to the outer cross-section of the pipe end 154 in such a way that only a small gap remains between the outer wall of the pipe end 154 and the inner wall of the fitting 152.

The lapped joint formed in this way between pipe end 154 and fitting 152 forms the joining area 150 in which fitting 152 and pipe end 154 are to be welded together.

In order to carry out the orbital welding process, the welding head 104 is first adjusted to the open position via the adjustment actuating element 122 so that the movable part 162 of the welding head 104 clears the insertion opening 164 (FIG. 2a). The hand-held device 102 with the welding head 104 can then be placed on the joining area 150 of the pipe end 154 and the fitting 152 pushed onto it with the insertion opening 164 from the side, so that the joining area 150 is located in the receptacle 106 (FIG. 2b), while the remaining part of the fitting 152 and the remaining part of the pipe end 154 extend out of the receptacle 106 through the openings 166, 168.

The welding head 104 is then adjusted to the closed position by means of the adjustment actuating element 122 (FIG. 2c). In the closed position, the joining area 150 of pipe end 154 and fitting 152 is preferably fixed in the receptacle 106 in a form-fitting and/or force-fitting manner by the fixed part 160 and the movable part 162 of the welding head 104, in particular fixed in the axial direction and, more preferably, also in the azimuth direction.

Furthermore, this fixing preferably also causes alignment of pipe end 154 and fitting 152, particularly preferably centering of pipe end 154 in fitting 152.

In FIG. 5a, the contours 200, 202 fixing the fitting 152 and the pipe end 154 are shown schematically with dashed lines. The fixing is carried out in particular in such a way that the joining area 150 is located in the area of the welding electrode 126. The welding electrode 126 is directed obliquely inwards, in particular at an angle to the radial direction in the range 5-45°, for example 45°, and may be directed obliquely in the circumferential direction, i.e. in the welding direction, for example at an angle in the range 0-15° to the radial direction. The welding electrode 126 points with its tip toward the lapped joint in the arrangement shown in FIG. 5a. The contours 200, 202 may, in particular, belong at least partially to the one or more contacting elements 178 in order to connect fitting 152 and pipe end 154 in an electrically conductive manner to an output of the welding current source 128.

The contours 200 are in particular adapted to the outer contour of the fitting. The contours 200, 202 fixing the fitting 152 and pipe end 154 may in particular be designed to brace the fitting 152 and the pipe end 154, in particular to hold them in a force-fitting manner. Such fixing of the fitting 152 and/or pipe end 154 enables reliable electrical contact of the fitting 152 or the pipe end 154 to be achieved.

The orbital welding device 100 with the welding head 104 and the fitting 152 form a system 700.

In the closed position of the welding head 104, the joining area 150 is preferably completely enclosed in the circumferential direction so that the protective gas supplied during the orbital welding process is retained in the joining area 150 and the environment, in particular the user, is protected from welding fumes and UV light generated during the orbital welding process.

After the welding head 104 has been adjusted to the closed position, the user can trigger the start of the orbital welding process, for example by pressing the torch trigger 138. The control unit 130 controls the electrode drive 124 and the welding current source 128 in such a way that the welding electrode 126 produces a chain of joining spots 210 in the circumferential direction, which connect the fitting 152 and the pipe end 154 in a material-locking manner.

FIGS. 5a-b schematically show the creation of a joining spot 210. To create a first joining spot 210, the welding current source 128 first generates a high-voltage pulse, which causes a contactless ignition of an arc between the welding electrode 126 and the fitting 152 or pipe end 154. The welding current source 128 then controls the welding current in accordance with a welding current characteristic curve, which comprises in particular a sequence of high-current phases and low-current phases. During the high-current phases, the heat input caused by the arc leads to the formation of a molten pool (also referred to as a weld pool) at the lapped joint of fitting 152 and pipe end 154, which solidifies at least partially during the low-current phase and forms a joining spot 210. To ensure that the next joining spot is created offset in the circumferential direction from the previous joining spot, the control unit 130 controls the electrode drive 124 so that it moves the welding electrode 126 further in the circumferential direction, and the welding current source 128 causes a new molten pool to be melted in the next high-current phase for the adjacent joining spot, which preferably overlaps with the first joining spot. A new ignition is not necessary for the second and subsequent joining spots, since the arc preferably burns continuously until the last joining spot.

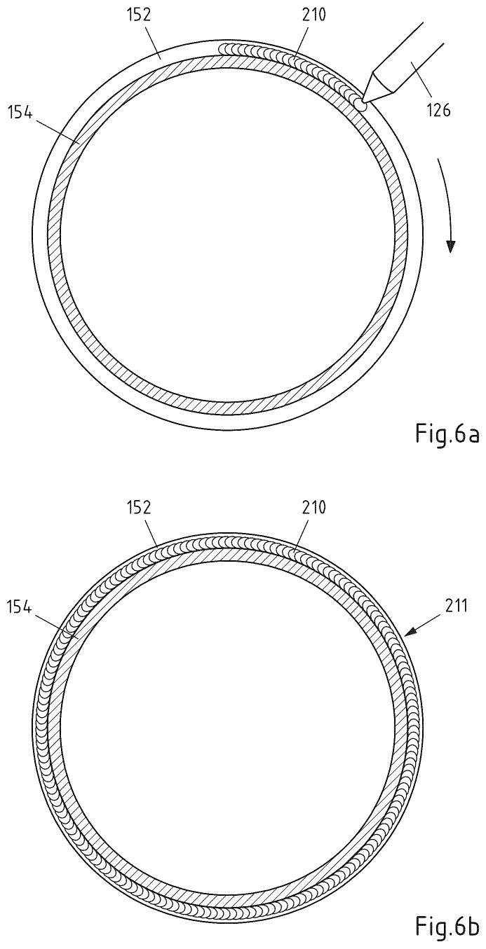

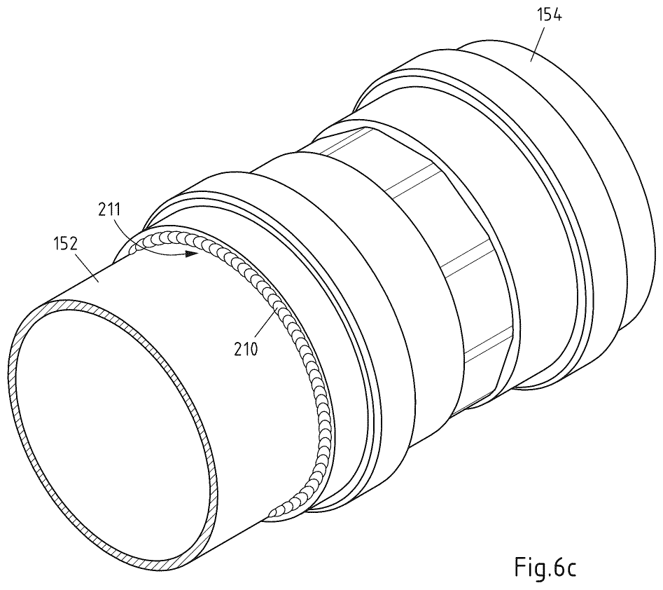

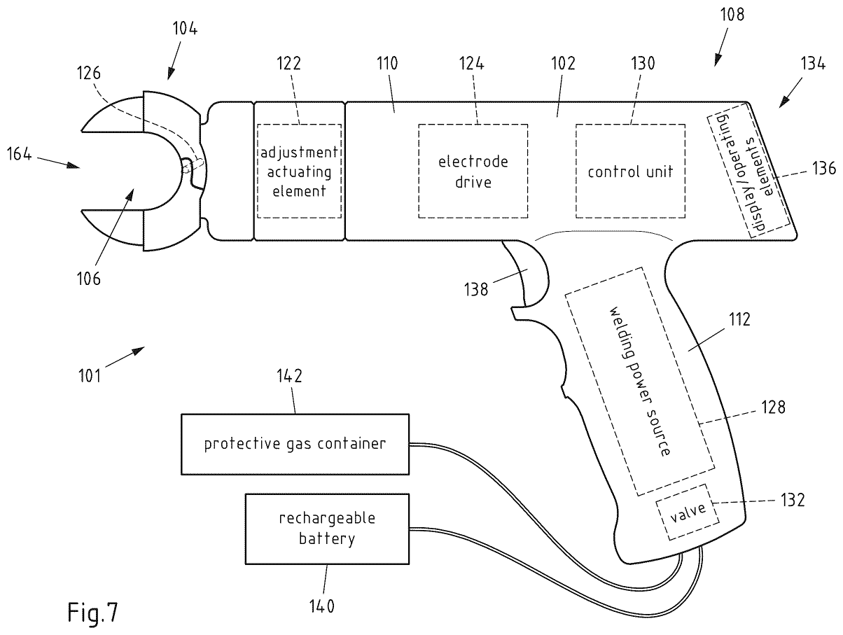

In this way, the chain of joining spots 210 is gradually created, through which the fitting 152 and pipe end 154 are preferably connected to each other in a fluid-tight manner at the lapped joint. FIGS. 6a-b show the creation of the joining spots 210 in schematic cross-sectional views corresponding to the cutting plane designated “VIa” in FIG. 5a, wherein FIG. 6a shows a point in time during the ongoing orbital welding process and FIG. 6b shows a point in time after completion of the orbital welding process. FIG. 6c shows a perspective view of the finished joint seam (weld seam) of fitting 152 and pipe end 154.

After the finished joint seam has been produced, the welding current source 128 reduces the welding current to zero so that the arc is extinguished. By actuating the adjustment actuating element 122, the welding head 104 can then be adjusted back into the open position by the user, and the welding head 104 can be removed laterally from the now materially bonded fitting 152 and pipe end 154.

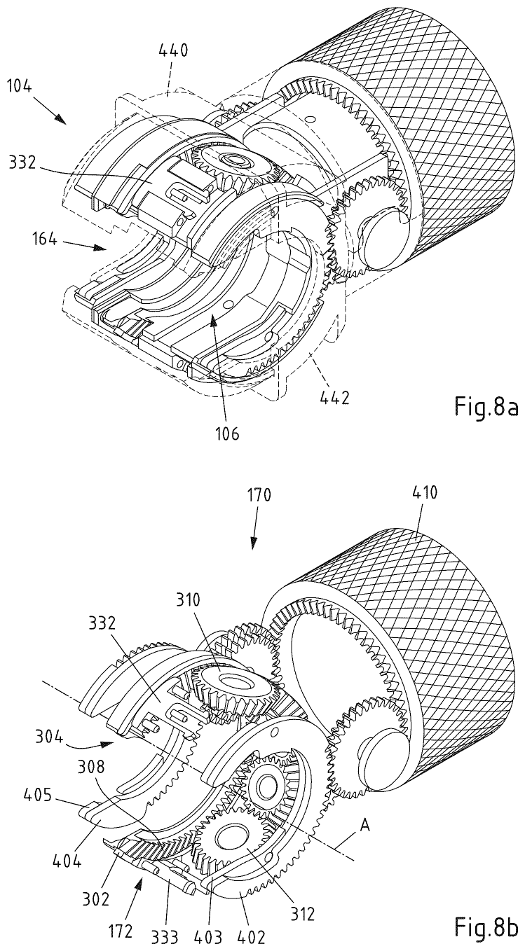

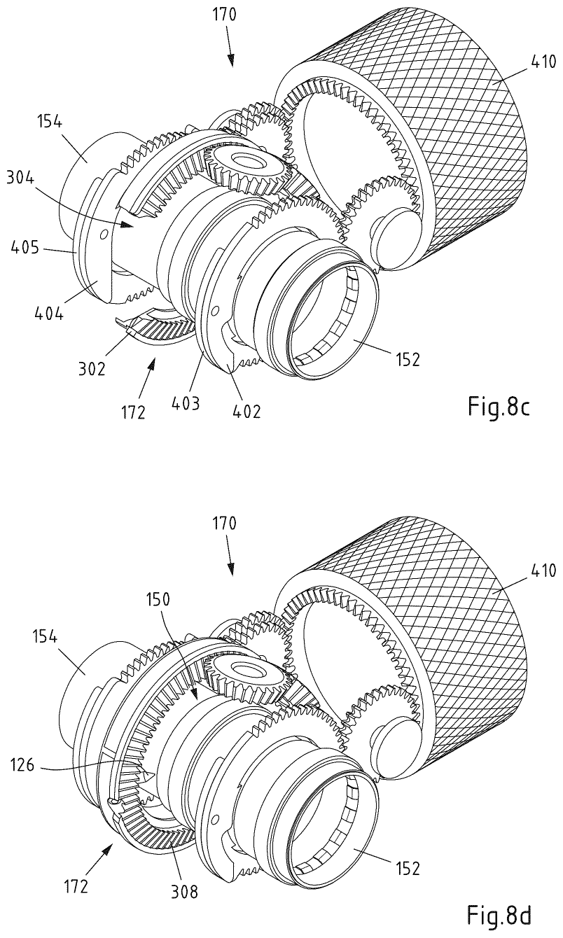

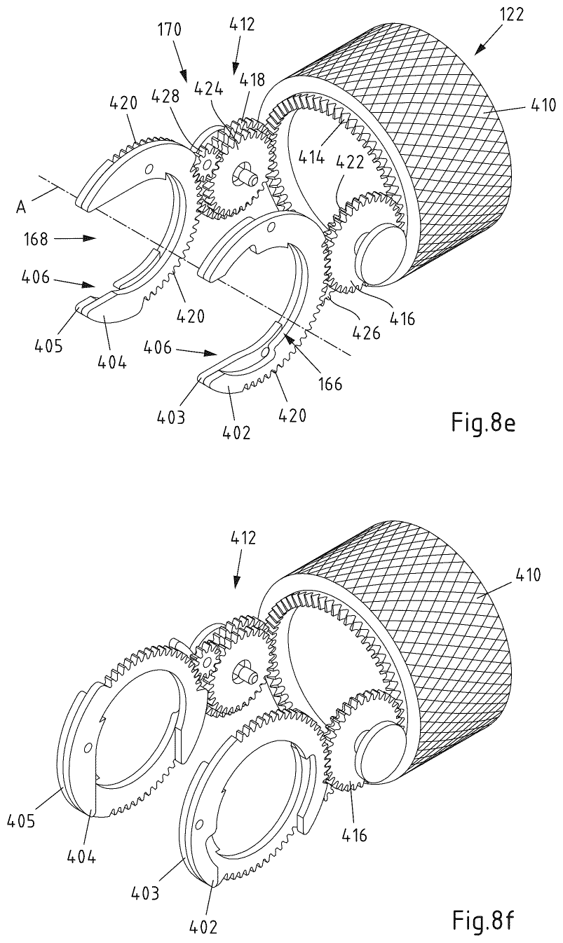

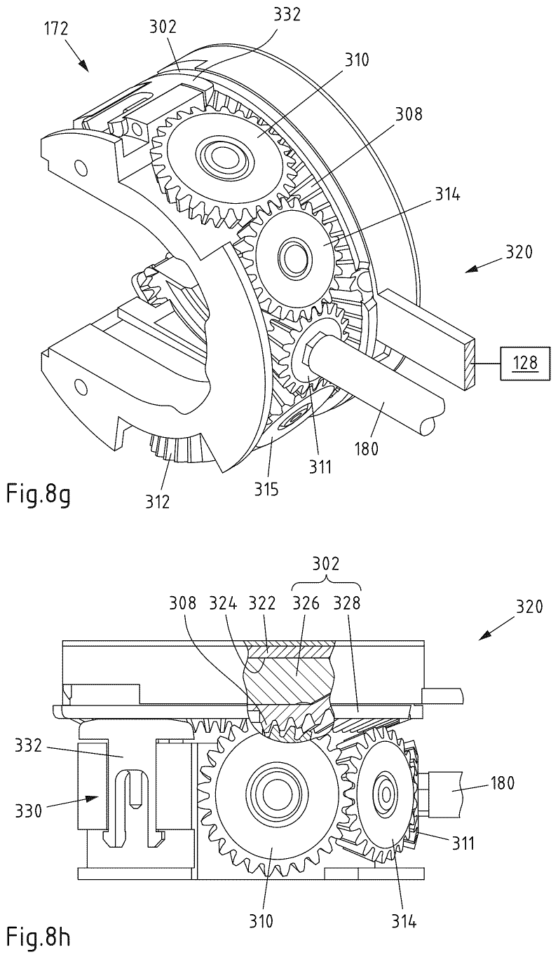

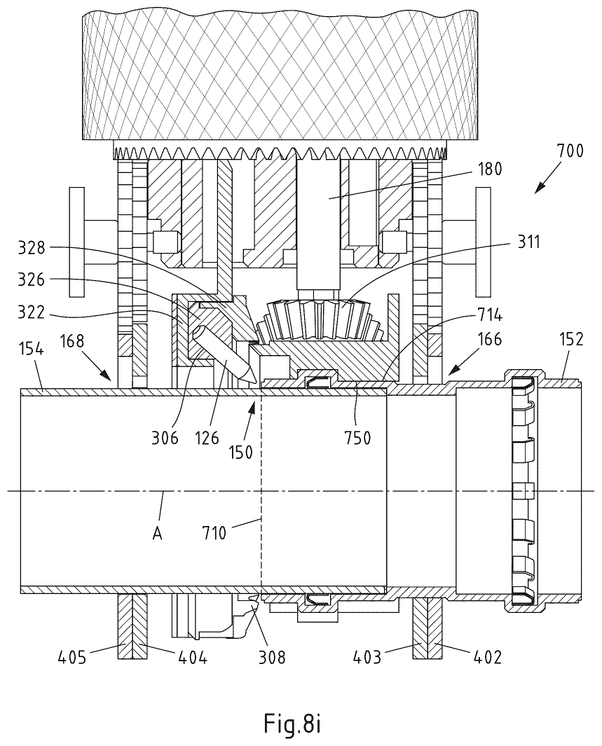

FIG. 7 shows a further exemplary embodiment of the orbital welding device. The orbital welding device 101 has a similar structure and mode of operation to the orbital welding device 100. Functionally corresponding components are therefore assigned the same reference symbols, even if they may be arranged or designed differently in some respects, and reference is made to the above description of FIGS. 1-6c and the following description of FIGS. 8a-i.

The orbital welding device 101 differs from the orbital welding device 100 in that some components, in FIG. 7 the protective gas container 142 and the rechargeable battery 140, are designed separately from the hand-held device and are connected to it by corresponding gas or power lines. In this way, the hand-held device can be made more compact and lighter. Furthermore, larger protective gas containers 142 and rechargeable batteries 140 can be used in this way. The protective gas container 142 and the rechargeable battery 140 may, for example, be arranged in a separate case or backpack.

Instead of a rechargeable battery, a mains connection for supplying power to the hand-held device 102 of the welding current source 128 may also be provided. This allows longer operation, albeit with more limited flexibility in handling.

FIGS. 8a-i show more detailed views of the welding head 104 of the orbital welding device 100 from FIG. 1 and of the orbital welding device 101 from FIG. 7, respectively. FIG. 8a shows the welding head 104 in perspective view, with the outer components being shown partially transparent with dashed lines. FIGS. 8b-d show the electrode circulation mechanism 172 and the adjustment mechanism 170 in perspective view, in the open (FIG. 8b) and closed position of the welding head (FIGS. 8c-d) and in the initial position (FIGS. 8b-c) and rotated position of the electrode circulation mechanism 172 (FIG. 8d). In FIGS. 8c-d, the joining area 150 of fitting 152 and pipe end 154 is also inserted into the receptacle 106. FIGS. 8e-f show a perspective view of the adjustment mechanism 170 in the open (FIG. 8e) and closed position of the welding head 104 (FIG. 8f). FIGS. 8g-h show the electrode circulation mechanism 172 and the contacting means 320 in perspective view (FIG. 8g) and in view from above (FIG. 8h). FIG. 8i shows the welding head 104 with the joining area 150 of fitting 152 and pipe end 154 arranged in the receptacle 106 in sectional view.

The welding head 104 comprises the receptacle 106 for positioning a joining area 150 of two joining partners, which are tubular at least in the joining area 150, namely a fitting 152 and a pipe end 154.

The electrode circulation mechanism 172 of the welding head 104 comprises a C-shaped electrode ring segment 302, which is arranged in the circumferential direction around the receptacle 106 and is mounted in the welding head 104 in such a way that it can rotate endlessly around an imaginary longitudinal axis A of the receptacle 106, i.e. through any angle. The electrode ring segment 302 has a ring segment opening 304 in the circumferential direction, the size of which is adapted to the insertion opening 164 and which, in the open position (see FIG. 8b), is arranged such that it forms part of the insertion opening 164.

The electrode ring segment 302 has an electrode holder 306 for the welding electrode 126, which can be inserted into the electrode holder 306 or is inserted therein. When the welding electrode 126 is worn, it can be removed from the electrode holder 306 and a new welding electrode can be inserted.

The electrode ring segment 302 is designed as a bevel gear segment and accordingly has a bevel gear toothing 308 on one side. The electrode circulation mechanism 172 further comprises several, in this case two, drive wheels 310, 312 arranged in the circumferential direction around the receptacle in the form of drive bevel gears, which engage with the bevel gear toothing 308 of the electrode ring segment 302. The drive bevel gears 310, 312 are arranged such that, in every rotational position of the electrode ring segment 302, at least one of the drive bevel gears 310, 312 is in engagement with the bevel gear toothing 308 of the electrode ring segment 302. The drive bevel gears 310, 312 are coupled to the electrode drive 124 via an axle 180 by means of a coupling bevel gear 311 and further coupling bevel gears 314, 315 arranged between the coupling bevel gear 311 and the drive bevel gears 310, 312. The axes of rotation of the drive bevel gears 310, 312 and coupling bevel gears 311, 314, 315 lie in a plane transverse to the longitudinal axis A. This ensures synchronous and uniform movement of the drive bevel gears 310, 312.

Furthermore, contacting means 320 are provided for electrical contacting of the electrode ring segment 302 and the welding electrode 126 and for electrical connection to the welding current source 128.

The contacting means 320 comprise a contacting ring segment 322 which is arranged offset in the axial direction next to the electrode ring segment 302 and is electrically conductively connected or connectable to the welding current source 128. The contacting ring segment 322 is preferably completely conductive on the side 324 facing the electrode ring segment 302 or has one or more conductive sections on the side 324.

The electrode ring segment 302 is also electrically conductive on the side facing the contact ring segment 322. In the present exemplary embodiment, the electrode ring segment 302 is designed in multiple parts and has a conductive ring segment 326 made of conductive material, for example copper, on the side facing the contact ring segment 322, and a drive ring segment 328 on the side facing the drive bevel gears 310, 312 which drive ring segment carries the bevel gear toothing 308. The drive ring segment 328 is preferably made of insulating material, for example plastic. The electrode holder 306 is formed by the conductor ring segment 326 or is electrically conductively connected thereto.

In order to ensure large-area contact between the conductor ring segment 326 and the contact ring segment 322 during rotation of the electrode ring segment 302 for transmission of the welding current with as little loss and interruption as possible, pressing means 330 in the form of a plurality of spring-mounted pressing elements 332, 333 are provided in the welding head 104, which pressing means press the electrode ring segment 302 against the conductor ring segment 326 and thus press these two components against each other. The pressing elements 332, 333 are distributed in the circumferential direction so that at least one of the pressing elements 332, 333 is in contact with the electrode ring segment 302 in every rotational position of the electrode ring segment 302.

The welding head 104 further has several C-shaped closure ring segments 402, 403, 404, 405, each of which being arranged in the circumferential direction around the receptacle 106 and being mounted in the welding head 104 in such a way that it can rotate about the longitudinal axis A of the receptacle.

The closure ring segments 402, 403, 404, 405 are each arranged in pairs next to each other, namely two closure ring segments 402, 403 in the region of the first opening 166 and two closure ring segments 404, 405 in the region of the second opening 168.

The closure ring segments 402, 403, 404, 405 each have a ring segment opening 406 in the circumferential direction, the size of which is adapted to the insertion opening 164.

The closure ring segments 402-405 can each be adjusted between an open rotational position (see FIG. 8e) and a closed rotational position (see FIG. 8f), whereby the direction of rotation from the open rotational position to the closed rotational position of the closure ring segments 402 and 403 as well as, respectively, 404 and 405 arranged directly next to each other is opposite in each case.

In order to adjust the closure ring segments 402-405 from the open rotational position to the closed rotational position, the orbital welding device 100 has an actuating element 410 in the form of a handle sleeve. The actuating element 410 is coupled to the closure ring segments 402-405 via a gear 412, so that by rotating the actuating element 410, the closure ring segments 402-405 can be adjusted synchronously from the open rotational position to the closed rotational position or from the closed rotational position to the open rotational position.

The gear 412 comprises a crown wheel 414 provided on the actuating element 410, which on the side of the closure ring segments 402, 403 and on the side of the closure ring segments 404, 405 respectively meshes with a gear wheel 416, 418, the respective axes of rotation of which being transverse to the axis of rotation of the actuating element 410. The gear wheel 416 is in turn coupled to the closure ring segments 402, 403 and the gear wheel 418 is coupled to the closure ring segments 404, 405. For this purpose, the closure ring segments 402-405 have respective outer toothing 420, whereby the gear wheels 416, 418 are coupled directly to the outer toothing 420 of the respective outer closure ring segment 402, 405 and to the outer toothing 420 of the respective inner closure ring segments 403, 404 via a smaller gear wheel 422 or 424 connected coaxially and rotationally fixed to the respective gear wheel 416, 418 and an intermediate gear wheel 426 or 428 arranged therebetween for changing the direction of rotation. The transmission ratio from gear wheel 416 to the external toothing 420 of closure ring segment 402 is equal to the transmission ratio from gear wheel 424 to the external toothing 420 of closure ring segment 404. Furthermore, the transmission ratio from gear wheel 422 to the external teeth 420 of the closure ring segment 403 is equal to the transmission ratio from gear wheel 418 to the external teeth 420 of the closure ring segment 405. Furthermore, the transmission ratio from gear wheel 416 to the external teeth 420 of closure ring segment 402 is equal to the transmission ratio from gear wheel 422 to the external teeth 420 of closure ring segment 403.

In this way, the rotary movement of the actuating element 410 can be transmitted synchronously to all four closure ring segments 402-405 with different directions of rotation. The use of the crown wheel 414 allows, in particular, a particularly compact redirection of the rotary movement. Furthermore, the use of the rotationally fixed gear wheels 422, 424 with the intermediate gear wheels 426, 428 allows a particularly compact reversal of the direction of rotation for the respective adjacent closure ring segments 402, 403 and 404, 405, respectively.

In the open position (see FIGS. 8a, b & e), the closure ring segments 402-405 are positioned in their respective open rotational positions, in which the respective ring segment opening 406 of the closure ring segments 402-405 is positioned in such a way that it forms part of the insertion opening 164.

In the closed position (see FIGS. 8c, d, f & i), the closure ring segments 402-405 are positioned in their respective closed rotational positions, in which the closure ring segments 402-405 are each positioned such that they partially close the insertion opening 164.

In order to close the insertion opening 164 as completely as possible in the closed position, the welding head 104 has an upper cover 440 and a lower cover 442, which are each connected in a rotationally fixed manner to two closure ring segments 402 and 405 (upper closure ring segments) and 403 and 404 (lower closure ring segments), respectively, such that the covers 440, 442 clears the insertion opening 164 in the open position of the welding head 104 and close it in the closed position of the welding head 104.

The actuating element 410 constitutes the adjustment actuating element 122 of the orbital welding device 100; and the closure ring segments 402-405 with the gear 412 constitute the adjustment mechanism 170 of the orbital welding device 100.

FIG. 8i shows the welding head 104 with the joining area 150 of the pipe end 154 and the pushed-on fitting 152 arranged in the receptacle 106 in sectional view. The fitting 152 has an outer contour 714 and the welding head 104 has a corresponding fitting fixing contour 750 in order to fix the fitting 152 in a predetermined fitting position when the welding head 104 is in the closed position, so that the fitting opening 710 assumes a predetermined position relative to the welding electrode 126, in particular a predetermined distance from the tip of the welding electrode 126. The fitting fixing contour 750 corresponds to the contour 202 schematically indicated in FIG. 5a. Preferably, the welding electrode 126 maintains the specified distance or distance range from the fitting opening 710 in every rotational position of the welding electrode 126, so that the orbital welding process can be carried out with a very small distance between the welding electrode 126 and the fitting opening 710.

The closure ring segments 402-405 are preferably designed to clamp the fitting 152 and the pipe end 154 in the specified position. For this purpose, the sealing ring segments 402-405 may, for example, be designed to be slightly springy, for example by forming the sealing ring segments 402-405 themselves from a springy material and/or by mounting the sealing ring segments 402-405 in a springy manner. In this way, reliable electrical contact between fitting 152 and pipe end 154 is also achieved by the closure ring segments 402-405.

The orbital welding device 100 with the welding head 104 and the fitting 152 with the outer contour 714 adapted to the fitting fixing contour 750 form a system 700.

### LIST OF REFERENCE SYMBOLS

100,101 orbital welding device
102 hand-held device
104 welding head
106 receptacle
108 handle part
110 shaft
112 handle
114 connection for an exchangeable battery unit
115 connection for a protective gas unit
116 rechargeable battery unit
120 protective gas magazine
122 adjustment actuating element
124 electrode drive
126 welding electrode
128 welding current source
130 control unit
132 valve
134 user interface
136 display and operating elements
138 trigger
140 rechargeable battery
142 protective gas container
150 joining area
152 fitting
154 pipe end
160 fixed part
162 movable part
164 insertion opening
166 first opening
168 second opening
170 adjustment mechanism
172 electrode circulation mechanism
174, 176 outputs of the welding current source
178 contacting elements
180 axle
182 microprocessor
184 memory
186, 188 inputs
190 electronic circuit
192 welding current control
194 HV ignition 200,202 contours
210 joining spot
302 electrode ring segment
304 ring segment opening
306 electrode holder
308 bevel gear toothing
310, 312 drive bevel gears
311, 314, 315 coupling bevel gears
320 contacting means
322 contact ring segment
324 one side of the electrode ring segment
326 conductive ring segment
328 drive ring segment
330 pressing means
332, 333 pressing elements
402, 403, 404, 405 closure ring segment
406 ring segment opening
410 actuating element
412 gear
414 crown wheel
416, 418 gear wheel
420 outer toothing
422, 424 gear wheels
426, 428 intermediate gear wheels
440 upper cover
442 lower cover
700 system
710 fitting opening
714 fitting outer contour
750 fitting fixing contour

1. An orbital welding device
with a welding head that has a receptacle for positioning a joining area of two joining partners, in particular a fitting and a pipe end which joining partners are tubular at least in the joining area,
wherein
the welding head has an electrode ring segment which is arranged in the circumferential direction around the receptacle and is mounted in such a way that the electrode ring segment can be rotated about an imaginary longitudinal axis of the receptacle,
the electrode ring segment has an electrode holder for a welding electrode and/or a welding electrode and
the welding head has drive means, in particular one or more driven drive wheels, for driving the electrode ring segment about the imaginary longitudinal axis.

2. OrbitalThe orbital welding device according to claim 1,
wherein the welding head has a plurality of driven drive wheels which are arranged such that, in each rotational position of the electrode ring segment about the imaginary longitudinal axis, at least one of the plurality of drive wheels, is coupled to the electrode ring segment.

3. The orbital welding device according to claim 1,
wherein the electrode ring segment is designed as a bevel wheel segment, in particular a bevel gear wheel segment, and the one or more drive wheels; are designed as drive bevel wheels, in particular drive bevel gear wheels, wherein preferably, in each rotational position of the electrode ring segment around the imaginary longitudinal axis, at least one of the plurality of drive gear wheels meshes with the bevel gear wheel segment.

4. The orbital welding device according to claim 1,
wherein the plurality of drive wheels, are arranged in the circumferential direction around the receptacle.

5. The orbital welding device according to claim 1,
wherein at least two of the plurality of drive wheels are rotationally coupled to one another, preferably by coupling wheels in particular coupling bevel wheels, provided between the drive wheels.

6. The orbital welding device according to claim 1,
wherein the orbital welding device comprises an electrode drive in particular a motor, which is rotationally coupled to at least one of the drive wheels for driving the same.

7. The orbital welding device according to claim 1,
wherein contacting means are provided for electrically contacting the electrode ring segment or a welding electrode on the electrode ring segment and for electrical connection to a welding current source or to a connection for a welding current source

8. The orbital welding device according to claim 1,
wherein a contacting ring segment is arranged next to the electrode ring segment which contacting ring segment is electrically conductively connected to a welding current source or to a connection for a welding current source

9. The orbital welding device according to claim 1,
wherein in the electrode ring segment is designed in multiple parts with a drive ring segment for coupling with the drive wheels and with a conductor ring segment for contacting the electrode ring segment.

10. The orbital welding device according to claim 1,
wherein in pressing means are provided which are designed to press the electrode ring segment and one or more contacting elements of the contacting means, in particular the contacting ring segment against one another.

11. The orbital welding device according to claim 10,
wherein the pressing means comprise a plurality of pressing elements in particular spring-loaded pressing elements, which are distributed in the circumferential direction.

12. The orbital welding device according to claim 1,
wherein in the orbital welding device comprises a welding current source which is electrically connected to the electrode ring segment, the welding electrode and/or the electrode holder therefor.

13. The orbital welding device according to any claim 1,
wherein
the welding head has a first opening and a second opening opposite the first opening, between which the receptacle extends in the longitudinal direction,
the welding head is adjustable between an open position and a closed position, wherein the welding head in the open position, has an insertion opening connecting the first and second opening for inserting a joining area of two joining partners, which are tubular at least in the joining area, into the receptacle, and wherein the insertion opening is at least partially closed in the closed position.

14. The orbital welding device according to claim 13,
wherein
the electrode ring segment has a ring segment opening in the circumferential direction, which forms part of the insertion opening when the welding head is in the open position.

15. The orbital welding device according to claim 1,
wherein the orbital welding device, comprises a hand-held device which comprises the welding head and preferably a handle part connected to the welding head-.

16. The orbital welding device according to claim 1,
wherein a control device is provided which is configured to control the orbital welding device in such a way that a weld seam consisting of a circumferential chain of joining spots is produced on two joining partners arranged in the receptacles.

17. A system
with an orbital welding device according to claim 1, and
with a fitting.

18. An orbital welding method, in particular carried out with an orbital welding device according to claim 1,
in which two tubular joining partners, which are tubular at least in a joining area are arranged relative to each other, in particular in a lapped joint,
in which a chain of joining spots extending in the circumferential direction of the joining partners is produced in the joining area, which chain connects the joining partners in a material-locking manner.

19. The orbital welding method according to claim 18,
wherein, for producing the chain of joining spots, the electrode ring segment is moved in the circumferential direction, in particular over an angle of at least 340°, in particular at least 360°.
